(19) United States
(12) Patent Application Publication
(10) Pub. No.: US 2011/0059354 A1
(43) Pub. Date: Mar. 10, 2011

(54) PRESSURIZED LOW VOLTAGE BATTERY

(76) Inventor: Sueng-Nien KAO, Taipei (TW)

(21) Appl. No.: 12/555,858

(22) Filed: Sep. 9, 2009

(51) Int. Cl. H01M 2/10

(52) U.S. Cl. 429/186

(57) ABSTRACT

A pressurized low voltage battery has a lower receptacle, two conductive rods, an upper receptacle and a stopper. The lower receptacle is mainly filled with active carbon powder surrounding by a piece of absorbent paper. The two conductive rods as opposite electrodes of the battery extend into the lower receptacle. The upper receptacle engages the lower receptacle and is partitioned into an air room and a water room for storing water. When the stopper is repeatedly pushed into the air room, water in the upper receptacle is able to be spread quickly to the active carbon powder in the lower receptacle via the absorbent paper to cause a chemical reaction. Therefore, the battery generates electricity soon.

### BACKGROUND OF THE INVENTION

1. Field of the Invention

The present invention relates to a pressurized low voltage battery, and more particularly to a low voltage battery that quickly spreads water in the battery by pressurizing water so that water cause a reaction between electrodes to produce stable voltage.

2. Description of Related Arts

Due to the increasing awareness of the need for environmental protection, people gradually realize that the limited natural resources may possibly be exhausted soon. Therefore, significant scientific resources have been devoted to the development of new energy forms having lower pollution, especially in the field of electricity development.

The well known power supply means, the battery, has also been improved to mitigate its contamination to the environment. For example, a salt solution in accompaniment with zinc and copper that are respectively applied as the cathode and anode for a battery, are able to generate electricity for providing power to a small electrical appliance, such as the calculator and the LED-based clock. However, such a zinc-copper battery still has some shortcomings needing to be overcome.

During the chemical reaction of the two electrodes and the salt solution, an electrolyte residue is generated and clouds the salt solution. As a result, the electricity generating ability of the battery is decreased and the salt solution must be refreshed which is inconvenient. Moreover, since the salty water is used as the electrolyte, the electrodes deteriorates too quickly, resulting in a short use life of the battery.

U.S. Pat. No. 7,011,906, issued to the same applicant and entitled to “Battery for an electrical appliance that consumes low voltage battery” is proposed to overcome the foregoing shortcomings. The battery described in the patent utilizes water to replace salt solution. The water reacts with a positive electrode and a negative electrode to produce electricity. If the water can quickly spread to the electrodes, the battery is able to generate electricity soon.

Therefore, the present invention provides a pressurized low voltage battery to facilitate the reaction in the battery for producing electricity soon.

### SUMMARY OF THE INVENTION

The objective of the present invention is to provide a pressurized low voltage battery. The pressurized low voltage battery produces output voltage soon even when the battery is used for the first time and remains to output a stable voltage.

The pressurized low voltage battery has a lower receptacle, two conductive rods, an upper receptacle and a stopper. The lower receptacle is mainly filled with active carbon powder surrounding by a piece of absorbent paper. The two conductive rods as opposite electrodes of the battery extend into the lower receptacle. The upper receptacle engages the lower receptacle and is partitioned into an air room and a water room that stores water.

When the stopper is repeatedly pushed into the air room, water in the upper receptacle spreads quickly to the active carbon powder due to the air pressure via the absorbent paper and causes a chemical reaction. Therefore, the battery generates electricity soon.

Further, the water absorbent bar can absorb water from the upper receptacle to the lower receptacle at a stable rate to remain the chemical reaction. Therefore, the battery water consumption is precisely controlled and the battery can produce a stable voltage.

The features and structure of the present invention will be more clearly understood when taken in conjunction with the accompanying figures.

### BRIEF DESCRIPTION OF THE DRAWINGS

FIG. 1 is a perspective view of a pressurized low voltage battery in accordance with the present invention;

FIG. 2 is an exploded perspective view of the pressurized low voltage battery in accordance with the present invention;

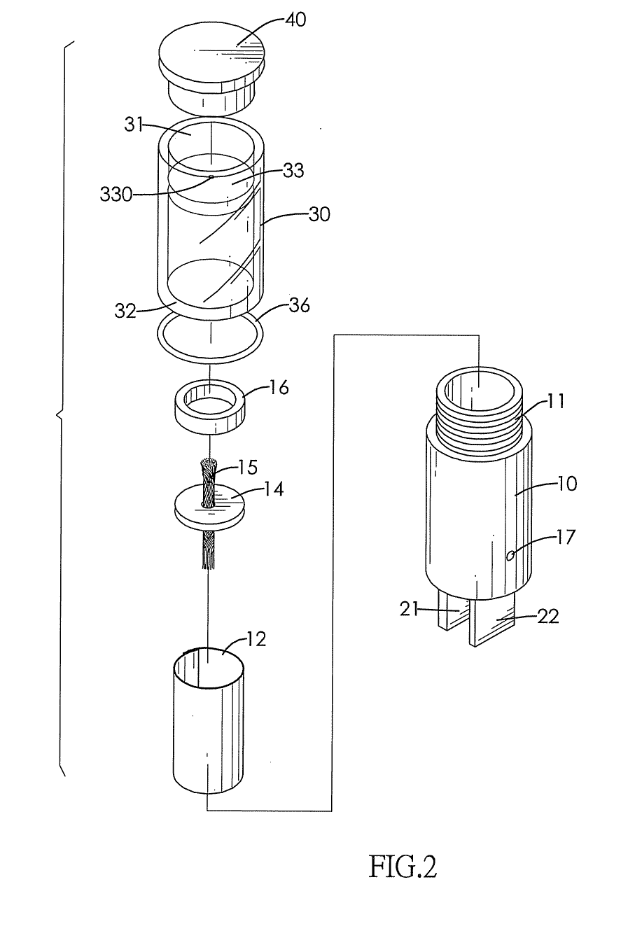

FIG. 3 is a cross-sectional view of the pressurized low voltage battery, wherein a stopper is separated from a top room;

FIG. 4 is a cross-sectional view of the pressurized low voltage battery, wherein the stopper is mounted in a half of the top room; and

FIG. 5 is a cross-sectional view of the pressurized low voltage battery, wherein the stopper is full mounted top room.

### DETAILED DESCRIPTION OF THE PREFERRED EMBODIMENT

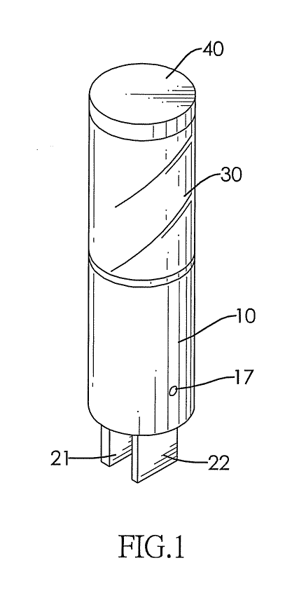

With reference to FIG. 1, a pressurized low voltage battery in accordance with the present invention comprises a lower receptacle (10), a piece of absorbent paper (12), active carbon powder (13), a rubber pad (14), an absorbent bar (15), a block ring (16), two conductive rods (21)(22), an upper receptacle (30) and a stopper (40).

The lower receptacle (10) has a bottom, a chamber with an inner surface, a side wall, a top, a mounting portion (11) and an air vent (17). The mounting portion (11) with an opening communicating with the chamber is formed on and protrude from the top of the lower receptacle (10). In one embodiment, the mounting portion (11) has an outer surface with screw threads to engage the upper receptacle (30). The air vent (17) is formed through the side wall and communicates with the chamber.

The piece of the absorbent paper (12) is full attached on the inner surface of the chamber of the lower receptacle (10), and the chamber is then filled with the active carbon powder (13).

The rubber pad (14) is mounted above the active carbon powder (13) and a top edge of the paper (12) and defined with a central hole. The rubber pad (14) has a periphery abutting against the inner surface of the chamber.

The absorbent bar (15), such as a cotton bar, is mounted through the central hole of the rubber pad (14), with one end embedded in the active carbon powder (13).

The block ring (16) is mounted on the rubber pad (14) and tightly abuts against the inner surface of the chamber to limit the rubber pad (14) and the active carbon power (13) in their positions, preventing the rubber pad (14) from departing from the chamber.

The two conductive rods (21)(22) are used as opposite electrodes of the battery. One end of each conductive rod (21)(22) extends into the chamber and contacts the active carbon powder (13). The other end of each conductive rod (21)(22) as a free end protrudes through the bottom of the lower receptacle (10) for electrically connecting to a circuit board or a wire. One of the conductive rods (21)(22) is composed of an alloy of magnesium and aluminum, and the other rod is composed of copper.

The upper receptacle (30) is transparent and has a top opening (31), a bottom opening (32), a channel communicating the top opening (31) and the bottom opening (32) and a partition (33). The partition (33) is mounted in the channel near the top opening (31) to separate the channel into an air room (34) and a water room (35) for storing water (50). The partition (33) is defined with a small through hole (330). The upper receptacle (30) is assembled to the lower receptacle (10). In one embodiment, the inner surface of the channel near the bottom opening (32) is formed with inner screw threads to screw the mounting portion (11) of the lower receptacle (10) correspondingly. A washer (36) may be applied between the upper receptacle (30) and the lower receptacle (10) to avoid a liquid leakage. Preferably, the washer (36) is mounted around the mounting portion (11).

The stopper (40) is detachably mounted in the top opening (31) to stuff full the air room (34).

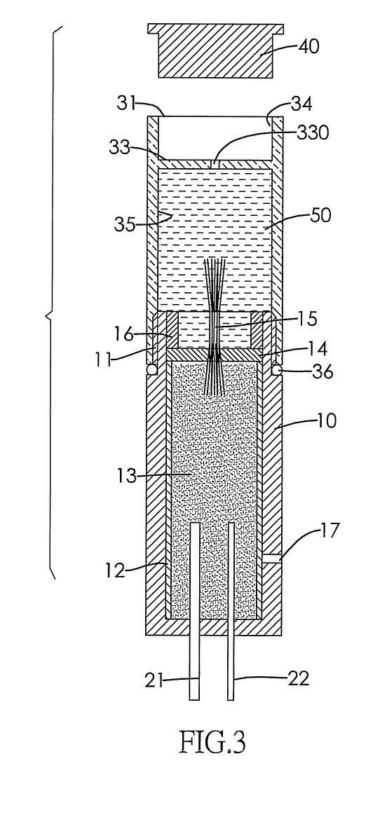

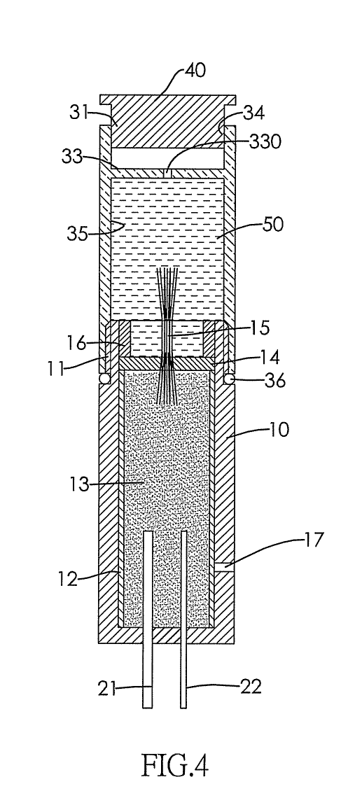

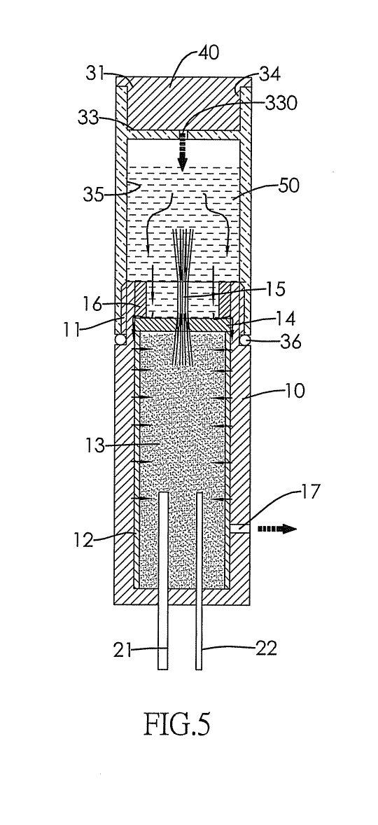

With further reference to FIGS. 3 to 5, when the battery is used for the first time, the water room (35) of the upper receptacle (30) is filled with water (50), and the upper receptacle (30) is then attached to the lower receptacle (10). When the absorbent bar (15) dipped in the water (50) becomes saturated, the water (50) is drawn into the active carbon powder (13) in the lower receptacle (10) because of the capillary feature of the absorbent bar (15) and the water (50) causes a reaction between the two conductive rods (21)(22). To facilitate diffusion of the water (50), the stopper (40) can be repeatedly detached from and plugged into the air room (34), whereby air is pressed from the air room (34) into the water room (50) via the small through hole (330). Due to the air pressure, the water (50) will flow to the absorbent paper (12) through the seam between the block ring (15) and the rubber pad (14) and the seam between the periphery of the rubber pad (14) and the inner surface of the chamber, as indicated by the arrow symbols. By repeating the pressurizing actions, the absorbent paper (12) in contact with the active carbon powder (13) will become saturated soon and the water (50) will spread to the active carbon powder (13) to cause a reaction between the two conductive rods (21)(22). Further, the absorbent paper (12) also prevents the active carbon powder (13) from flowing out through the air vent (17).

After the pressurizing actions, most of the water (50) initially stored in the water room (35) will spread into the lower receptacle (10) and the water room (35) is almost empty. A user can separate the upper lower receptacle (30) from the lower receptacle (10) and add supplemental water in the water room (35). The absorbent bar (15) continuously draws the supplemental water into the active carbon powder (13) in the lower receptacle (10). Therefore, the battery can possess enough water for reaction and produces a stable voltage.

When the output voltage of the battery drops, the water (50) in the battery may be exhausted. To solve the problem, the user just needs to disconnect the upper lower receptacle (30) from the lower receptacle (10) and easily refills the water room (35) with water.

With such an arrangement, when the batter is used for the first time, the stopper (40) is repeatedly plugged to quickly spread water to the lower receptacle (10) and cause a reaction. Therefore, the battery produces an output voltage soon.

Furthermore, the absorbent bar (15) can continuously draw the water (50) into the active carbon powder (13) in the lower receptacle (10) at a steady rate. Therefore, the water consumption is precisely controlled and the battery can produce a stable voltage.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A pressurized low voltage battery comprising:
a lower receptacle having a bottom, a chamber with an inner surface, a side wall, a top, and an air vent defined through the side wall;
a piece of absorbent paper full attached on the inner surface of the chamber of the lower receptacle;
active carbon powder filling the chamber and surround by the absorbent paper;
a rubber pad mounted above the active carbon powder and having a periphery abutting against the inner surface of the chamber;
an absorbent bar extending through the rubber pad and having
a first end embedded in the active carbon powder; and
a second end;
a block ring mounted on the rubber pad and tightly abutting against the inner surface of the chamber;
two conductive rods as opposite electrodes, each conductive rod having a first end extending into the chamber to contact the active carbon powder, and a second end protruding through the bottom of the lower receptacle;
an upper receptacle detachably engaging the lower receptacle, having a top opening, a bottom opening, a channel communicating the top opening and the bottom opening, and a partition having a though hole and mounted in the channel to separate the channel into an air room and a water room; wherein the second end of the absorbent bar extends to the water room;
a stopper detachably mounted in the top opening of the upper receptacle to stuff the air room.

2. The pressurized low voltage battery as claimed in claim 1, wherein the upper receptacle is detachably screwed to the lower receptacle.

3. The pressurized low voltage battery as claimed in claim 2, wherein the lower receptacle further has a mounting portion formed on the top of the lower receptacle and having outer screw threads to correspondingly engage inner screw threads formed on an inner surface of the channel of the upper receptacle near the bottom opening.

4. The pressurized low voltage battery as claimed in claim 3, wherein a washer is mounted around the mounting portion and between the upper receptacle and the lower receptacle.

5. The pressurized low voltage battery as claimed in claim 1, wherein the rubber pad is mounted above a top edge of the absorbent paper.

6. The pressurized low voltage battery as claimed in claim 1, wherein one of the two conductive rods is composed of copper, and the other rod is composed of an alloy of magnesium and aluminum.

7. The pressurized low voltage battery as claimed in claim 2, wherein one of the two conductive rods is composed of copper, and the other rod is composed of an alloy of magnesium and aluminum.

8. The pressurized low voltage battery as claimed in claim 3, wherein one of the two conductive rods is composed of copper, and the other rod is composed of an alloy of magnesium and aluminum.

9. The pressurized low voltage battery as claimed in claim 4, wherein one of the two conductive rods is composed of copper, and the other rod is composed of an alloy of magnesium and aluminum.

10. The pressurized low voltage battery as claimed in claim 5, wherein one of the two conductive rods is composed of copper, and the other rod is composed of an alloy of magnesium and aluminum.

11. The pressurized low voltage battery as claimed in claim 6, wherein the absorbent bar is a cotton bar.

12. The pressurized low voltage battery as claimed in claim 7, wherein the absorbent bar is a cotton bar.

13. The pressurized low voltage battery as claimed in claim 8, wherein the absorbent bar is a cotton bar.

14. The pressurized low voltage battery as claimed in claim 9, wherein the absorbent bar is a cotton bar.

15. The pressurized low voltage battery as claimed in claim 10, wherein the absorbent bar is a cotton bar.
